(19) United States
(12) Patent Application Publication
(10) Pub. No.: US 2026/0077280 A1
(43) Pub. Date: Mar. 19, 2026

(54) FILTER INSERT WITH IMPROVED FILTER PERFORMANCE UNDER OPERATING CONDITIONS

(71) Applicant: HENGST SE, Muenster (DE)

(72) Inventors: Sieghard PIETSCHNER, Greven (DE); Sebastian PIETRUSCHKA, Muenster (DE); Tobias SCHULTE WUELWER, Muenster (DE); Marcus WEGMANN, Ostbevern (DE); Christiane GAMERSCHLAG, Muenster (DE); Elisabeth TEWES, Muenster (DE)

(21) Appl. No.: 19/111,506

(22) PCT Filed: Sep. 13, 2023
(86) PCT No.: PCT/EP2023/075100

§ 371 Date: Oct. 9, 2025

(30) Foreign Application Priority Data
Sep. 16, 2022 (DE) 10 2022 123 809.1

(51) Int. Cl. B01D 29/21; B01D 29/58; B01D 36/00

(52) U.S. Cl. CPC B01D 29/21; B01D 29/58; B01D 36/008

(57) ABSTRACT

The invention relates to a filter insert for a fluid filter device, comprising: a) a first circumferential filter element comprising a first folded filter medium, b) a second circumferential filter element comprising a second folded filter medium, c) a first base element and a second base element, and d) a cover element with a fluid outlet, wherein the first filter element, the first base element, and the cover element form a first inner chamber, said second filter element being arranged in the first inner chamber, and the second filter element, the second base element, and the cover element form a second inner chamber, wherein the filter insert is designed so that a fluid to be filtered can flow from the outside through the first filter element into the first inner chamber, from the first inner chamber through the second filter element into the second inner chamber and out of the second inner chamber through the fluid outlet, The quotient of the filter surface area of the first filter element divided by that of the second filter element is greater than one, the quotient of the filter rating of the first filter medium divided by the filter rating of the second filter medium equals one or more, and the first filter medium and the second filter medium have a bending strength of 2.5 N*mm² or more according to DIN 53864:1978-08.

### DESCRIPTION

The invention relates to a filter insert for a fluid filter device and a fluid filter device comprising a corresponding filter insert. Also disclosed is the use of a corresponding filter insert or a fluid filter device for filtering fluids as well as an alternative filter unit.

There is fundamentally a continuous need in many industries for high-performance fluid filters with advantageous handling properties and high filter efficiency. Many of the improvements in these properties known from the prior art are achieved by the selection of suitable materials and/or by an improved design of the filters.

One area of technology in which there is a particularly high demand for high-performance filters is the field of automotive engineering, in which corresponding fluid filter devices are used in particular for filtering fuels, for example petrol or diesel. In addition to separating particulate contaminants, the fluid filter devices used are often also intended to fulfill other tasks, such as removing foreign liquids. Corresponding fluid filter devices for filtering fuels are known to a person skilled in the art and are disclosed, for example, in US 6328883 B1, US 8034240 B2 or US 5643446 A.

The performance of modern fluid filter devices or their filter inserts with regard to the separation efficiency and other properties is now regularly determined under controlled test conditions using mostly standardized test procedures with comparatively static ambient conditions. Many of the fluid filter devices for fuels known from the prior art show advantageous properties under these “laboratory conditions.”

In practice, however, in particular during later use in vehicles, it is often found that the filter properties in driving operation are not sufficient to meet the requirements for safe operation set by the vehicle manufacturers. While the focus of development to compensate for this observed problem in the past was mostly on further increasing the output filter properties under laboratory conditions, the development focus today is increasingly on increasing the robustness of the fluid filter devices against the stresses prevailing in use, so that the initial filter properties should experience as little deterioration as possible due to the stresses occurring during operation.

According to the opinion of the inventors, the main stresses experienced by a fuel filter under operating conditions in a vehicle, in particular in a commercial vehicle, include in particular mechanical vibrations of the fluid filter devices, which are caused, for example, by driving on the road or operating the engine, and fluctuations in the fluid flows flowing through the fluid filter devices, which are caused, for example, by switching the engine on and off or by a varying fuel supply to the engine. According to the opinion of the inventors, most of the fluid filter devices known from the prior art are not sufficiently robust with regard to the loads that occur under operating conditions in a vehicle, so that the filter performance under operating conditions is assessed as inadequate.

The primary object of the present invention was to eliminate or at least mitigate the disadvantages of the prior art described above.

In particular, it was the object of the present invention to provide a filter insert and an associated fluid filter device, in particular for fuel filtering, which show improved filter performance under typical operating conditions in a vehicle compared to the prior art, wherein in particular the robustness of the fluid filter device against mechanical vibrations and fluctuations in the fluid flow should be increased.

It was a further object of the present invention that the fluid filter device to be specified should also have excellent output filter properties.

In addition, it was a supplementary object of the present invention that the fluid filter device to be specified should be able to be designed in such a way that reliable water separation is possible even under typical operating conditions in a vehicle.

The inventors of the present invention have now recognized that the objects described above can surprisingly be achieved if, in a fluid filter device, a first filter element is combined with a second filter element which is arranged inside and is preferably shorter, provided that the folded filter media used in each case have a certain minimum bending strength and are designed with regard to the filter rating such that the filter medium of the inner filter has at least the same filter rating as the filter medium of the outer filter, as defined in the claims.

This surprisingly results in advantageous filter inserts and corresponding fluid filter devices which, under typical operating conditions in a vehicle, demonstrate improved filter performance compared to the prior art, wherein the filter performance under typical operating conditions surprisingly deviates only slightly from the filter performance in the standard test on the laboratory test bench in accordance with the current standard ISO 19438. Without wishing to be bound to this theory, the inventors assume that the sequential arrangement of two filter elements in conjunction with the higher bending strength of the multiply folded filter media contributes to a particularly favorable behavior under typical operating conditions, in particular with mechanical vibrations and fluctuating fluid flows, and in this respect complements the flow behavior of the fluid in a particularly advantageous manner, which is caused by the reduced filter surface area of the internal second filter element with at least an equally good filter rating. Again, without wishing to be bound by this theory, the inventors assume that the folded filter media provide better damping of mechanical vibrations and fluctuating fluid flows due to the increased bending strength stiffness, wherein in preferred embodiments the fluid chambers resulting from the shortened internal filter element advantageously contribute to compensating for load peaks that could otherwise adversely affect the filter performance under typical operating conditions.

The above-mentioned objects are thus achieved by the subject matter of the invention as defined in the claims. Preferred designs according to the invention are apparent from the dependent claims and the following embodiments.

Such embodiments, which are hereinafter designated as preferred, are combined in particularly preferred embodiments with features of other embodiments designated as preferred. Combinations of two or more of the embodiments referred to below as particularly preferred are thus very particularly preferred. Also preferred are embodiments in which a feature of one embodiment designated as preferred to any extent is combined with one or more other features of other embodiments designated as preferred to any extent. Features of preferred fluid filter devices, uses and filter units can be found in the features of preferred filter inserts.

The invention particularly relates to a filter insert for a fluid filter device, preferably a fuel filter, comprising:
a) a circumferential first filter element comprising a folded first filter medium,
b) a circumferential second filter element comprising a folded second filter medium,
c) a first base element and a second base element, and
d) a cover element with a fluid outlet,
wherein the first filter element, the first base element and the cover element form a first inner chamber, wherein the second filter element is arranged in the first inner chamber and wherein the second filter element, the second base element and the cover element form a second inner chamber,
wherein the filter insert is designed so that a fluid to be filtered can flow from the outside through the first filter element into the first inner chamber, from the first inner chamber through the second filter element into the second inner chamber and out of the second inner chamber through the fluid outlet,
wherein the quotient of the accessible filter surface area of the first filter element divided by the accessible filter surface area of the second filter element is greater than one, wherein the quotient of the filter rating of the first filter medium divided by the filter rating of the second filter medium equals one or more, wherein the filter rating is the filter rating determined according to ISO 19438:2003-11 for the overall separation efficiency, and
wherein the first filter medium and the second filter medium have a bending strength of 2.5 N*mm² or more according to DIN 53864:1978-08.

The filter insert according to the invention is intended for use in fluid filter devices, in particular in fuel filters. The filter insert can be firmly connected to a housing in the form of so-called spin-on filters. However, a filter insert according to the invention is preferred, wherein the filter insert is a replaceable filter insert which can be arranged, for example, in a filter housing of a fluid filter device according to the invention in a reversible and non-destructively replaceable manner. The filter insert according to the invention can be a pre-filter insert or a main filter insert, wherein the absolute values of the filter ratings vary between these designs, since higher values of the filter rating are regularly used for pre-filters.

In accordance with the understanding of a person skilled in the art, the filter insert according to the invention is described in the light of a mostly at least largely rotationally symmetrical structure with reference to the axial direction, which in the context of the present invention mostly runs between the cover element and the first base element and will expediently mostly coincide with the longitudinal direction of the filter elements, so that the filter elements are designed to be circumferential around this axial direction. Furthermore, for the description of the filter inserts according to the invention, regardless of any deviation from an ideal rotationally symmetrical structure, reference is also made to the radial direction, which is orthogonal to the axial direction.

Insofar as reference is made within the scope of the invention to the volume of the first inner chamber or the volume of the second inner chamber, this means in each case the entire volume of the particular inner chamber which is formed by the particular filter element, the cover element and the associated base element, wherein any openings in the elements, for example the outlet opening in the cover element or an opening for draining water from the first inner region, are hidden, so that the areas surrounding the openings are virtually extended beyond the opening when determining the volume of the inner chamber. This means that the volumes of the inner chambers are not differential volumes and are therefore not reduced by the volume of any components that may be arranged in the particular inner chamber. This means in particular that the volume of the first inner chamber is not reduced by the second filter element arranged in the first inner chamber or by the second inner chamber enclosed by the second filter element.

Analogously to filter inserts known from the prior art, the filter insert according to the invention initially comprises a circumferential first filter element, which is delimited at the upper end by a cover element with a fluid outlet and at the opposite end by a first base element. The circumferential first filter element, the cover element and the base element form a first inner chamber. Such a filter insert from the prior art would be designed so that a fluid to be filtered can flow from the outside through the first filter element into the first inner chamber and out of the first inner chamber through the fluid outlet.

In accordance with the understanding of a person skilled in the art, this first inner chamber does not have to be absolutely completely surrounded by these components, so that the fluid outlet in the cover element or any openings in the base element, which serve, for example, to drain water from the first inner chamber, can be present. At least theoretically, it is conceivable, for example, that an opening in the base element is so pronounced that it substantially corresponds to the cross-sectional area of the first inner chamber, so that the first base element substantially only serves to enclose the first filter element and the first inner chamber is substantially not delimited by the first base element.

In contrast to the usual design of the prior art, a second filter stage is provided in the filter insert according to the invention. For this purpose, a circumferential second filter element is provided, which is arranged inside the first inner chamber. The second filter element, together with the cover element arranged at one end and a second base element arranged at the opposite end, forms a second inner chamber, which accordingly also lies inside the first inner chamber.

A person skilled in the art will understand that the smaller radius of the inner second filter element usually means in practice that the filter surface of the second filter element accessible for filtering is reduced, so that the above definition of the filter surfaces will usually be met for design reasons alone. However, the corresponding gradient between the filter elements is considered by the inventors to be particularly advantageous, so that it is preferable to set larger gradients in this respect. Due to the relevance of the inflow area available for the fluid passage, a filter insert according to the invention is particularly preferred, wherein the quotient of the accessible filter surface area of the first filter element divided by the accessible filter surface area of the second filter element is 1.5 or more, preferably 3.0 or more, particularly preferably 4.5 or more.

A person skilled in the art will understand that the above-defined arrangement of the filter insert, namely that a fluid to be filtered can flow from the outside through the first filter element into the first inner chamber, from the first inner chamber through the second filter element into the second inner chamber and out of the second inner chamber through the fluid outlet, means, when interpreted by a person skilled in the art, that a fluid to be filtered cannot flow past the second filter element, i.e., bypassing the second filter stage, into the second inner chamber and/or out through the fluid outlet. In terms of construction, this can be achieved, for example, by designing the second base element without continuous recesses and arranging the resulting composite of the second filter element and the second base element above the fluid outlet in such a way that the fluid outlet is completely covered.

In filter inserts according to the invention, the first and the second filter element are each circumferential filter elements, which can be achieved in particular by a hollow cylinder-like basic shape, although polygonal base areas would also be conceivable, the boundaries being fluid anyway in view of the formation of the circumferential filter elements by folded filter media. In relation to the volumes of the inner chambers, a filter insert according to the invention is additionally or alternatively also preferred, in which the volume of the second inner chamber is 0.6*V₁ or less, preferably 0.5*V₁ or less, particularly preferably 0.4*V₁ or less, wherein Vi is the volume of the first inner chamber.

The filter elements each comprise filter media which are inserted in a folded form. Filter media and their use in the form of folded structures, which are sometimes also referred to by a person skilled in the art as so-called bellows, are comprehensively familiar to a person skilled in the art in the field of filter technology. Synthetic media are particularly interesting for filter media to be used according to the invention, although these can also be combined at least partially with natural materials such as cellulose fibers. According to the opinion of the inventors, a filter insert according to the invention is preferred, wherein the first filter medium and/or the second filter medium, preferably both filter media, consist at least partially, preferably predominantly, particularly preferably substantially completely, of a thermoplastic material selected from the group consisting of polyolefins, polyamides, polyurethanes, polycarbonates and polyesters, preferably selected from the group consisting of polyolefins and polyesters, particularly preferably selected from the group consisting of polyesters.

A circumferential first filter element can be obtained from such filter media, for example, by folding a flat filter medium into a zigzag shape when the ends of the resulting zigzag structure are placed on top of one another and connected to one another to obtain a cylindrical circumferential filter element of which the wall is formed by the folded filter medium. With respect to simple manufacture and advantageous filter performance, a filter insert according to the invention is preferred, wherein the first filter medium is a circumferentially arranged fold package, wherein the first filter medium comprises a plurality of substantially uniform folds, and/or wherein the second filter medium is a circumferentially arranged fold package, wherein the second filter medium comprises a plurality of substantially uniform folds, wherein the number of folds preferably differs between the first filter medium and the second filter medium.

A person skilled in the art will understand that the filter inserts according to the invention are very flexible with regard to the design of the individual components, provided that the designs do not conflict with the relationships described above. For example, it is possible to design the cover element or the base elements in several parts or to form the outlet opening with a plurality of holes instead of providing just one outlet opening.

As explained above, the filter insert according to the invention is a filter insert with two filter stages arranged one behind the other, which are formed by the first filter element and the second filter element. In the context of the present invention, the designation of the components, for example the fluid outlet, as well as the functional connection of the elements through the definition of the flowability are based on the usual operating direction that can reasonably be expected in practice. In this usual operating direction, a fluid to be filtered, for example a fuel, will flow from the outside through the first filter element into the first inner chamber, from the first inner chamber through the second filter element into the second inner chamber and then out of the second inner chamber through the fluid outlet. However, a person skilled in the art will understand that corresponding filter inserts according to the invention could, at least theoretically, also be operated with an inverted flow direction, so that a fluid to be filtered could be led through the fluid outlet into the second inner chamber, through the second filter element into the first inner chamber and out of the first inner chamber through the first filter element. However, since such use is unlikely to have any practical relevance anyway, this possibility will not be explained further below. In this respect, the inventors have not checked whether the positive technical effects of filter inserts according to the invention would also be apparent in this technically less sensible use. In fact, the inventors rather assume that for this purpose at least the above-defined relationships between the filter ratings and the filter surface areas, or the other relationships between the filter elements, would have to be inverted accordingly, so that in the resulting, alternative and non-inventive design, for example, the inner filter element would have to be made longer in order to realize a larger filter surface area despite the internal arrangement.

In practice, the filter elements will in many cases consist entirely of the filter media, especially in the case of comparatively simple structural designs. However, it is also conceivable that, in addition to the filter media, further elements are provided in the filter elements, which serve, for example, to separate water, as disclosed below. In addition, the filter elements can also comprise frame elements or similar and, at least theoretically, can also be designed in several parts, for example as connected half-shells, although a one-piece design is particularly preferred. In this respect, a person skilled in the art will readily understand that the filter medium central to the filter elements in these embodiments will expediently extend over the entire length and the entire circumference of the filter elements. For substantially all embodiments, a filter insert according to the invention is preferred, wherein the first filter medium extends in the axial direction over the entire length of the first filter element, and/or wherein the second filter medium extends in the axial direction over the entire length of the second filter element. For substantially all embodiments, additionally or alternatively preferred is also a filter insert according to the invention, wherein the first filter medium extends over the entire circumference of the first filter element, and/or wherein the second filter medium extends over the entire circumference of the second filter element. Particularly preferred is a filter insert according to the invention, wherein the first filter element consists of the first filter medium, and/or wherein the second filter element consists of the second filter medium.

From a manufacturing point of view, it is preferred if the filter elements are spaced apart from one another in the radial direction. In this respect, however, the inventors have found that the setting of a corresponding intermediate region, i.e., the part of the first inner chamber which lies between the first filter element and the second filter element, is also advantageous with regard to the robustness of the filter property under operating conditions. A filter insert according to the invention is preferred, wherein the first filter element and the second filter element are spaced apart from one another in the radial direction, so that the first inner chamber comprises an intermediate region arranged between the first filter element and the second filter element, wherein the average distance is in the range of 3 to 20 mm, preferably in the range of 5 to 10 mm.

The base elements can advantageously be designed to be very flexible, wherein, in the opinion of the inventors, flat, plate-shaped base elements are preferred. A filter insert according to the invention is preferred, wherein the first base element and/or the second base element, preferably the first base element and the second base element, are flat end plates, preferably circular end disks, which are connected to the first filter element or the second filter element. In particular, in the case of filter elements of substantially equal length, it is possible for the first base element and the second base element to be formed by the same component, so that the first base element and the second base element are formed by an overall base element.

A filter insert according to the invention is preferred, wherein the cover element is connected directly, i.e., for example without further frame or support structures, to the first filter element and the second filter element. The cover element can be made up of several parts, for example by two cover parts that are screwed together, but is preferably made in one piece. A filter insert according to the invention is preferred, particularly because of its simple design, wherein the cover element is a circular end disk in which the fluid outlet is arranged substantially centrally. The cover element can have a macroscopic structure on the side facing the filter elements, so that the cover element can, for example, partially protrude into the first inner chamber, whereby it is possible, for example, to place the second filter element further down in the first inner chamber relative to the first filter element and, so to speak, to sink it somewhat deeper into this first inner chamber. However, in the opinion of the inventors, it is particularly preferred if the cover element is designed to be largely flat or level on the side facing the filter elements, so that the filter elements connected to the cover element are substantially at the same height. In particular, when using a shortened inner filter element, this arrangement results in a chamber region from the difference in length of the filter elements, which is described in more detail below and which, in the opinion of the inventors, leads to a particularly advantageous filter performance under typical operating conditions.

Accordingly, a filter insert according to the invention is preferred, wherein the end of the first filter element pointing in the direction of the cover element and the end of the second filter element pointing in the direction of the cover element are offset by 0.05*L₁ or less, preferably around 0.02*L₁ or less, particularly preferably around 0.01*L₁ or less, with respect to the axial direction, where L₁ is the length of the first filter element in the axial direction.

In particular, if the ends of filter elements of different lengths pointing in the direction of the cover elements are arranged substantially at the same height, a free space is created in the first inner chamber between the two base elements in preferred filter inserts according to the invention, which is referred to as a chamber region in the context of the present invention, wherein such a chamber region can also be obtained by an offset arrangement in the case of filter elements of equal length. The design of the filter insert according to the invention with such a chamber area is, in the opinion of the inventors, particularly advantageous for achieving a particularly advantageous filter performance under typical operating conditions, in particular when using shorter internal filter elements. A filter insert according to the invention is therefore preferred, wherein the first base element and the second base element are spaced apart from one another in the axial direction, so that the first inner chamber comprises a chamber region arranged between the first base element and the second base element. A filter insert according to the invention is preferred, wherein the volume proportion of the chamber region in the first inner chamber is 10% or more, preferably 12.5% or more, particularly preferably 15% or more.

In order to achieve advantageous robustness against loads under typical operating conditions, the filter inserts according to the invention combine the concept of two-stage filtration, or the resulting difference in the available filter surface area between the filter elements, with a specification for the absolute bending strength of the filter materials used and a specification for their filter rating.

The inventors have recognized that a certain minimum bending strength must be set, in particular for both filter media, in order to achieve excellent filter performance even under the typical loads under operating conditions in the vehicle. The bending strength of the filter media is determined according to DIN 53864:1978-08, wherein the bending strength is determined in the context of the invention with a bending angle of 5°. If the bending strength is determined on a filter medium that has already been folded, the determination is made by bending parallel to the fold direction, i.e., usually the axial direction in the filter insert, in order to eliminate any influence of the folding on the bending strength.

According to the opinion of the inventors, the minimum bending strengths required are above the typical bending strengths known for the filter media typically used in the prior art. The inventors have found that particularly rigid filter media lead to particularly favorable filter properties under typical operating conditions. Thus, a filter insert according to the invention is preferred, wherein the first filter medium has a bending strength of 4.0 N*mm² or more, preferably 5.5 N*m² or more, particularly preferably 7.0 N*mm² or more, most preferably 10.0 N*mm² or more, most preferably 13.0 N*mm² or more, particularly preferably 16.0 N*mm² or more. Additionally or alternatively, a filter insert according to the invention is also preferred, wherein the second filter medium has a bending strength of 4.0 N*mm² or more, preferably 5.5 N*mm² or more, particularly preferably 7.0 N*mm² or more, most preferably 10.0 N*mm² or more, most preferably 13.0 N*mm² or more, particularly preferably 16.0 N*mm² or more.

In their own tests, the inventors have found that very high bending strengths in some filter structures can lead to less favorable filter properties. Against this background, a filter insert according to the invention is preferred, wherein the first filter medium has a bending strength in the range of 2.5 N*mm² up to 34.0 N*mm², preferably in the range of 3.0 N*mm² up to 32.0 N*mm², particularly preferably in the range of 3.5 N*mm² up to 28.0 N*mm², most preferably in the range of 4.0 N*mm² up to 24.0 N*mm². A filter insert according to the invention is also preferred, wherein the second filter medium has a bending strength in the range of 2.5 N*mm² up to 34.0 N*mm², preferably in the range of 3.0 N*mm² up to 32.0 N*mm², particularly preferably in the range of 3.5 N*mm² up to 28.0 N*mm², most preferably in the range of 4.0 N*mm² up to 24.0 N*mm².

A person skilled in the art understands that the bending strength of the filter media is related to the effective bending strength of the entire filter medium.

When using composite materials made of two or more different materials, the effective composite bending strength of the actual filter medium must be determined accordingly and not the bending strength of the pure materials. For certain applications, for example, a filter insert according to the invention is preferred, wherein the first filter medium and/or the second filter medium is a composite material, preferably a composite material made of a plastic and an inorganic fiber material, for example carbon fiber or glass fiber, preferably glass fiber. For example, a filter insert according to the invention is also conceivable, wherein the first filter medium and/or the second filter medium are a composite material made of a plastics material and a metal, for example a composite material made of a textile fabric and a metal grid structure. Additionally or alternatively, the minimum bending strength of the filter media can also be achieved by a macroscopic structuring which does not involve folding, for example by providing so-called grooving, wherein the grooves preferably run substantially transversely to the folding direction of the filter elements.

The inventors consider it particularly advantageous if a gradient is also set between the bending strengths of the filter media used. In this respect, according to the opinion of the inventors, particularly advantageous performance properties result for filter inserts according to the invention in which the bending strength of the first filter medium corresponds at least to the bending strength of the second filter medium, wherein the bending strength of the first filter medium should preferably be selected to be greater, whereby not only excellent filter properties under mechanical stress can be achieved, but also greater flexibility with regard to the design of the second filter medium is achieved. A filter insert according to the invention is preferred, wherein the quotient of the bending strength of the first filter medium divided by the bending strength of the second filter medium equals one or more, wherein the quotient of the bending strength of the first filter medium divided by the bending strength of the second filter medium is preferably greater than one. A filter insert according to the invention is preferred, wherein the quotient of the bending strength of the first filter medium divided by the bending strength of the second filter medium is 1.1 or more, preferably 1.2 or more, particularly preferably 1.5 or more. Additionally or alternatively, a filter insert according to the invention is preferred, wherein the quotient of the bending strength of the first filter medium divided by the bending strength of the second filter medium is 10 or less, preferably 5 or less, particularly preferably 2.5 or less. In addition or as an alternative, a filter insert according to the invention is particularly preferred, wherein the quotient of the bending strength of the first filter medium divided by the bending strength of the second filter medium is in the range from 1.05 to 10, preferably in the range from 1.15 to 5, particularly preferably in the range from 1.25 to 2.5.

Another feature that the inventors have identified as important for achieving high filter performance under operating conditions is the filter rating of the filter media used or their relationship to one another. In accordance with the expert understanding, the term filter rating in the context of the present invention refers to the filter rating according to ISO 19438:2003-11, corresponding to the “filter rating” (cf. point 3.5 of ISO 19438:2003-11), which indicates the “filter rating” at different separation efficiencies, for example 90%, 95% or 99%, and which is determined according to the specifications of ISO 19438:2003-11 in the light of the overall separation efficiency, corresponding to the “cumulative overall efficiency,” and indicates for which particle sizes a corresponding overall separation efficiency is achieved. In order to evaluate whether the quotient of the filter rating of the first filter medium divided by the filter rating of the second filter medium equals one or more, a person skilled in the art can in practice choose a separation efficiency as a reference point that enables an advantageous resolution and accordingly results in clearly distinguishable filter ratings, since the filter medium with the better filter rating will regularly be better at all separation efficiencies. In case of doubt, in particular when assessing whether specific filter rating quotients are achieved, the filter reference rating according to ISO 19438:2003-11, corresponding to the “filter reference rating” (cf. point 3.6 of ISO 19438:2003-11), which indicates the “filter rating” at a separation efficiency of 99%, is used in accordance with professional practice.

The inventors have recognized that the filter rating of the second filter medium should at least not be selected to be higher, i.e., worse, than the filter rating of the first filter medium, wherein on the contrary it is preferred if the filter rating of the second filter medium is selected to be lower. Accordingly, a filter insert according to the invention is preferred, wherein the quotient of the filter rating of the first filter medium divided by the filter rating of the second filter medium is 1.01 or more, preferably 1.02 or more, particularly preferably 1.05 or more.

Thus, firstly, a filter insert according to the invention is preferred, in particular a main filter insert, wherein the first filter medium has a filter rating of 5.0 μm(c) or less, preferably 4.0 μm(c) or less, particularly preferably 3.0 μm(c) or less, and/or wherein the second filter medium has a filter rating of 5.0 μm(c) or less, preferably 4.0 μm(c) or less, particularly preferably 3.0 μm(c) or less. For pre-filter inserts, it is advisable to set values for the filter rating that are 10 times higher.

According to the opinion of the inventors, a difference in length between the filter elements can achieve an additional improvement in filter performance under typical operating conditions. Without wishing to be bound by this theory, the inventors assume that the resulting increased difference in the area of the filter medium available for passage in each filter stage and the resulting additional reduction in the passage area in the second filter stage is advantageous in order to compensate for the loads occurring with fluctuating fluid flows. According to the opinion of the inventors, larger differences in length are in principle advantageous. According to the opinion of the inventors, it is also preferable to set a difference in length between the filter elements because, in addition to the effects of different radii and possibly different folds, this expresses both a larger minimum difference in the available passage area of the filter media and the constructive dimension that the fluid flow is at least partially deflected on the way from the first to the second filter element, wherein the formation of a chamber area in particular is considered to be particularly advantageous. Thus, a filter insert according to the invention is preferred, wherein the first filter element is 10% or more, preferably 15% or more, particularly preferably 20% or more, longer in the axial direction than the second filter element. However, since the throughput can be adversely affected, in particular with very small second filter elements, the inventors propose that the difference in length should be chosen within a certain range. In this respect, a filter insert according to the invention is additionally or alternatively preferred, wherein the length of the first filter element L₁ in the axial direction is in the range of 1.1*L₂ up to 2.5*L₂, preferably in the range of 1.2*L₂ up to 2.0*L₂, particularly preferably in the range of 1.3*L₂ up to 1.7*L₂, wherein L₂ is the length of the second filter element in the axial direction.

In embodiments with a shortened inner filter element, a filter insert according to the invention is preferred in relation to the distance between the base elements delimiting the particular filter elements, wherein the distance between the first base element and the second base element in the axial direction is in the range of 0.1*L₁ up to 0.6*L₁, preferably in the range of 0.2*L₁ up to 0.5*L₁, particularly preferably in the range of 0.25*L₁ up to 0.45*L₁, wherein L₁ is the length of the first filter element in the axial direction.

In particularly preferred embodiments, the filter insert according to the invention can be combined in an efficient manner with a multi-stage water separation. Corresponding concepts for multi-stage water separation in fuel filters as well as the materials used therein are known to a person skilled in the art on the basis of his specialist knowledge and can advantageously be integrated into filter inserts according to the invention without any loss in separation performance.

With regard to the first stage of water separation, a filter insert according to the invention is preferred, wherein the first filter element comprises a fluid-permeable circumferential coalescer layer for agglomerating liquid contaminants dispersed in the fluid (which is sometimes also referred to by a person skilled in the art as coagulation), in particular water droplets, wherein the coalescer layer is preferably arranged on the side of the first filter element facing the first inner chamber, wherein the coalescer layer particularly preferably extends in the axial direction over the entire length of the first filter element, and wherein the first base element comprises a water outlet opening for discharging agglomerated liquid contaminants from the first inner chamber, wherein the water outlet opening is preferably arranged centrally in the first base element.

Particularly preferred is a filter insert according to the invention, wherein the coalescer layer is arranged on the surface of the first filter medium, wherein the coalescer layer is preferably folded or wound, particularly preferably folded complementarily to the first filter medium. In addition or as an alternative, a filter insert according to the invention is particularly preferred, wherein the coalescer layer comprises one or more materials selected from the group consisting of open-pore nonwoven materials, in particular open-pore nonwoven materials made of synthetic fibers

When using such a circumferential coalescer layer, a filter insert according to the invention is particularly preferred, wherein the first filter element consists of the folded first filter medium and the coalescer layer.

With regard to the first stage of water separation, a filter insert according to the invention is preferred, wherein the second filter element comprises a fluid-permeable circumferential separation layer for separating liquid contaminants present in the fluid, in particular water droplets, wherein the separation layer is preferably arranged on the side of the second filter element facing the first inner chamber, wherein the separation layer particularly preferably extends in the axial direction over the entire length of the second filter element.

Particularly preferred is a filter insert according to the invention, wherein the separation layer is designed as a sieve-like layer, preferably with an average opening diameter in the range of 10 to 200 μm, preferably in the range of 12 to 150 μm, particularly preferably in the range of 15 to 110 μm. In addition or as an alternative, a filter insert according to the invention is particularly preferred, wherein the separation layer comprises one or more hydrophobic materials, wherein the separation layer preferably consists of hydrophobic materials or is coated with hydrophobic materials, for example with polytetrafluoroethylene or comparable materials. Additionally or alternatively, a filter insert according to the invention is particularly preferred, wherein the separation layer is arranged on the surface of the second filter medium, wherein the separation layer is preferably folded, particularly preferably folded complementarily to the second filter medium.

When using such a circumferential separation layer, a filter insert according to the invention is particularly preferred, wherein the first filter element consists of the folded second filter medium and the separation layer.

The inventors propose that the filter inserts should be designed as main filter inserts in order to achieve an overall advantageous filter performance so that they achieve certain minimum separation efficiencies during trouble-free operation. In this respect, a filter insert according to the invention is preferred, wherein the filter insert in the standard test according to ISO 19438:2003-11, i.e., in vibration-free operation with a continuous fluid flow, i.e. vibration-and fluctuation-free, virtually without external mechanical stress, for particles with a particle size of ≥4 μm, has a separation efficiency of 99.3% or more, preferably 99.5% or more, particularly preferably 99.7% or more, very particularly preferably 99.9% or more, wherein the separation efficiency is the overall separation efficiency determined according to ISO 19438:2003-11, corresponding to the “cumulative overall efficiency”, for a particle size of ≥4 μm. For pre-filter inserts, the above information applies accordingly to the overall separation efficiency for a particle size of ≥10 μm.

In addition, the inventors have succeeded in identifying a criterion for main filter inserts with which high performance can be ensured under typical operating conditions, in particular in trucks, wherein the filter inserts according to the invention can advantageously be specifically designed so that these criteria are met. With regard to the mechanical loads occurring under typical operating conditions, a filter insert according to the invention is preferred, wherein the filter insert has a separation efficiency of 98% or more, preferably 99% or more, particularly preferably 99.5% or more, very particularly preferably 99.9% or more, for particles with a particle size of 4 μm when filtering in a vibrating state, preferably with vibration at a frequency in the range of 20 to 2000 Hz and an acceleration in the range of 2 to 7 G, wherein the separation efficiency is the overall separation efficiency determined in accordance with ISO 19438:2003-11 for a particle size of ≥4 μm, which is determined taking into account the vibration with diesel as the test fluid, and/or wherein the filter insert has a separation efficiency of 98% or more, preferably 99% or more, particularly preferably 99.5% or more, very particularly preferably 99.9% or more when filtering fluctuating volume flows, preferably when filtering volume flows fluctuating with an intensity of +10% or more, particularly preferably +20% or more, particularly preferably by 95 % or more, for particles with a particle size of 4 μm, wherein the separation efficiency is the overall separation efficiency determined in accordance with ISO 19438:2003-11 for a particle size of ≥4 μm, which is determined taking into account the fluctuation with diesel as the test fluid. For pre-filter inserts, the above information applies accordingly to the overall separation efficiency for a particle size of ≥10 μm.

The invention also relates to a fluid filter device for filtering a fluid, in particular a pre-filter or a main filter, comprising:
i) a filter housing, and
ii) a filter insert according to the invention arranged in the filter housing.

Also disclosed is the use of a filter insert according to the invention or a fluid filter device according to the invention in the filtering of fluids, in particular during the operation of vehicles, to improve the constancy of the filter performance under the influence of usual vehicle conditions, in particular vibrations and/or fluctuating volume flows, in particular dynamically fluctuating volume flows of the fluid.

A corresponding use is preferred, wherein the fluid is a fuel, in particular diesel. A corresponding use is preferred, wherein the vehicle is a commercial vehicle, in particular a truck.

The inventors consider filter inserts according to the invention, which make use of folded filter media as disclosed above, to be particularly relevant with regard to practical relevance, in particular because the effects of the invention are particularly evident in these cases. However, the inventors propose that by setting the filter surface area differences, bending strengths and filter ratings discussed above, advantageous inserts for fuel filters can still be obtained even with non-folded or only partially folded filter media. Accordingly, in connection with the invention, such inserts for fuel filters are also disclosed, which are referred to as filter units to distinguish them from filter inserts according to the invention. The preferred features disclosed above for filter inserts according to the invention apply accordingly to these disclosed filter units. Thus, a filter unit for a fluid filter device is disclosed, comprising:
a) a circumferential first filter element comprising a first filter medium,
b) a circumferential second filter element comprising a second filter medium,
c) a first base element and a second base element, and
d) a cover element with a fluid outlet,
wherein the first filter element, the first base element and the cover element form a first inner chamber, wherein the second filter element is arranged in the first inner chamber and wherein the second filter element, the second base element and the cover element form a second inner chamber,
wherein the filter insert is designed so that a fluid to be filtered can flow from the outside through the first filter element into the first inner chamber, from the first inner chamber through the second filter element into the second inner chamber and out of the second inner chamber through the fluid outlet,
wherein the quotient of the accessible filter surface area of the first filter element divided by the accessible filter surface area of the second filter element is greater than one, wherein the quotient of the filter rating of the first filter medium divided by the filter rating of the second filter medium equals one or more, wherein the filter rating is the filter rating determined according to ISO 19438:2003-11 for the overall separation efficiency, and
wherein the first filter medium and the second filter medium have a bending strength of 2.5 N*mm² or more according to DIN 53864:1978-08.

The invention and preferred embodiments of the invention are explained and described in more detail below with reference to accompanying figures, in which:

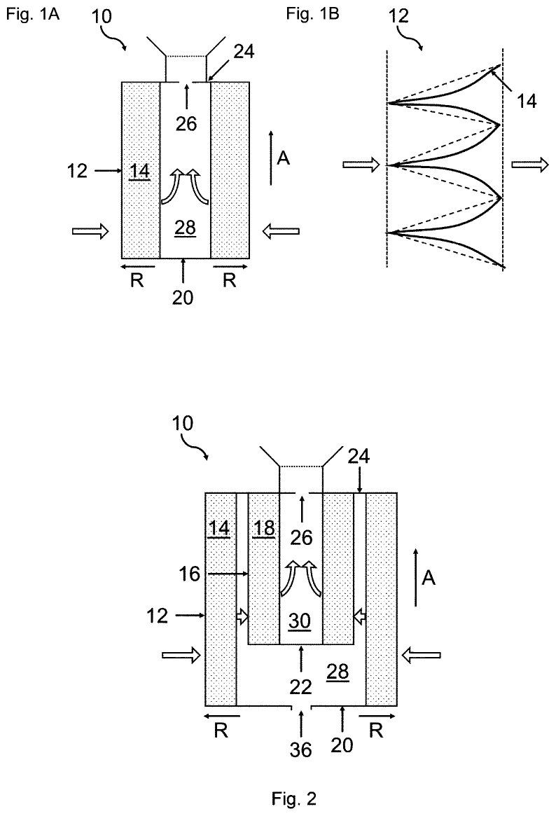

FIG. 1a is a schematic representation of a filter insert not according to the invention for a fluid filter device;

FIG. 1b is a schematic representation of a folded filter element and its deformation under operating conditions;

FIG. 2 is a schematic representation of a filter insert according to the invention for a fluid filter device in a preferred embodiment;

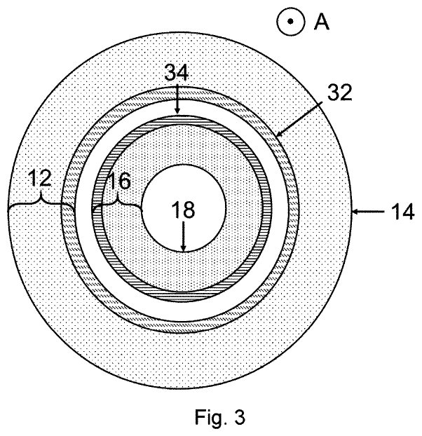

FIG. 3 is a schematic representation of a filter insert according to the invention for a fluid filter device in an alternative preferred embodiment;

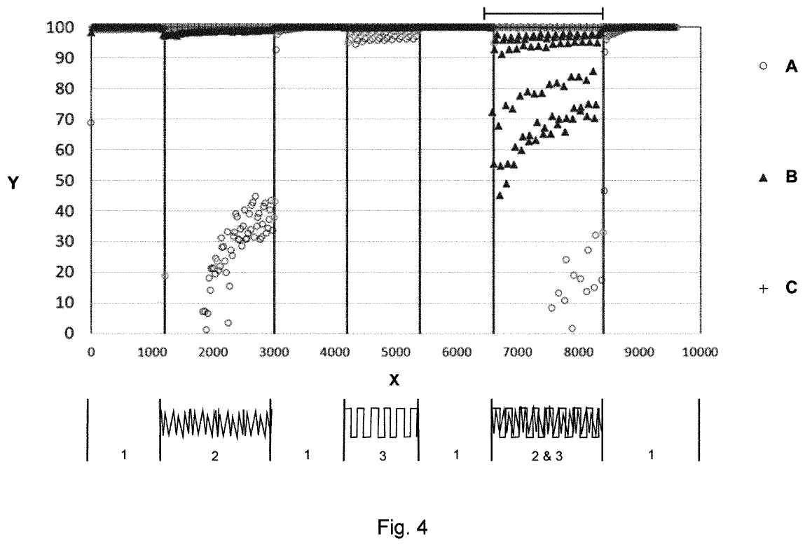

FIG. 4 is a graphical representation of measured overall separation efficiencies at ≥4 μm in % (Y) versus time (X) for different filter inserts under different load scenarios;

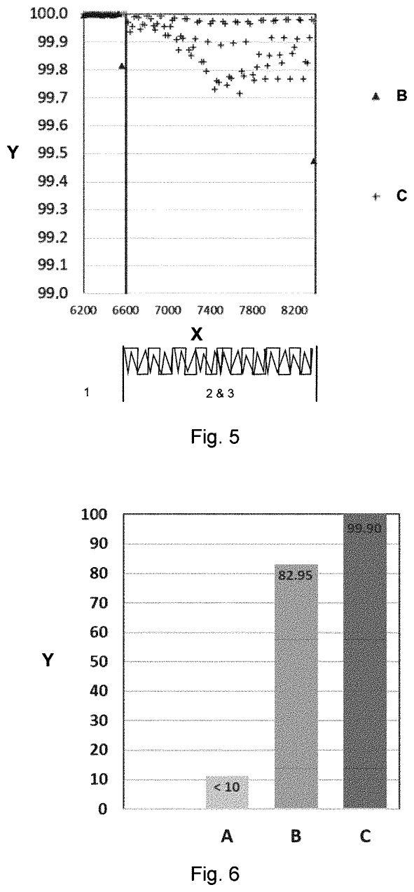

FIG. 5 is an enlarged view of a detail of the graphical representation of FIG. 4; and

FIG. 6 is a graphical representation of the overall separation efficiency at ≥4 μm for the different filter inserts of FIG. 4.

FIG. 1a) shows a cross-sectional representation of a filter insert 10 not according to the invention for a fluid filter device. The rotationally symmetrical filter insert 10 has a circumferential first filter element 12, which consists of a folded first filter medium 14 and is delimited at the top and bottom in the axial direction A by a cover element 24 and a first base element 20, both of which are connected to the filter element 12, so that the components together form a first inner chamber 28.

When filtering fluids, a fluid, for example diesel fuel, flows into the filter insert 10 from the outside in relation to the radial direction R and passes through the first filter medium 14. The fluid filtered in this single stage then flows out of the filter insert 10 again through a fluid outlet 26 in the cover element 24. The flow direction of the fluid is indicated in FIGS. 1a) and 1b) by unfilled direction arrows.

FIG. 1b) schematically visualizes the behavior of the first filter medium 14 of the filter insert 10 not according to the invention shown in FIG. 1a) using a cross-sectional representation in the plane perpendicular to the axial direction A under operating conditions on the vehicle, in particular with dynamically fluctuating volume flows. In the initial state, the folded first filter medium 14 is present in substantially uniform folds. This is indicated in FIG. 1b) by the dashed zigzag line. Under mechanical stress during use, this zigzag shape changes in such a way that the first filter medium 14 is partially deformed, in particular locally compressed or stretched, and accordingly changes its filter properties. Without wishing to be bound to this theory, the inventors assume that this can lead, among other things, to a change in the pore diameter of the first filter medium 14 during operation, so that, particularly in the case of fluctuating flows, i.e., the cyclic loading and unloading of the filter folds between the extreme states shown in FIG. 1b), the pores can at least partially open, thereby reducing the filter efficiency.

In contrast, FIG. 2 shows a schematic cross-sectional representation of a filter insert 10 according to the invention for fluid filter devices according to the invention, in which a corresponding filter insert 10 is inserted into a suitable housing, wherein the flow direction of the fluid is also indicated in FIG. 2 by unfilled direction arrows. The filter insert 10 shown is also substantially rotationally symmetrical, so that the filter elements encompassed by the filter insert 10 with folded filter media, which are sometimes also referred to by a person skilled in the art as bellows due to their nature, have a hollow cylindrical basic shape with respect to their envelope. As known from the prior art, a first inner chamber 28 of the filter insert 10 is formed by the first circumferential filter element 12, which is connected to a first base element 20 and a cover element 24. In the filter insert 10 according to the invention, in contrast to the prior art according to FIG. 1, however, a second inner chamber 30 is formed in the first inner chamber 28 in the radial direction R inside by a second circumferential filter element 16, which is connected to a second base element 22 and the cover element 24, so that an intermediate space is formed between the first filter element 12 and the second filter element 16, which can have a width of 8 mm in the radial direction R, for example.

In the example shown in FIG. 2, the first filter element 12 consists of a folded first filter medium 14 and the second filter element 16 consists of a folded second filter medium 18. In the axial direction A, the first filter element 12 in the preferred embodiment shown is approximately 40% longer than the second filter element 16, so that the length of the first filter element 12 L₁ corresponds to approximately 1.4 times the length of the second filter element 16 L₂. According to the different lengths of the filter elements, as well as the common closure in the axial direction A by the same, in this case integrally formed cover element 24, a distance is obtained between the first base element 20 and the second base element 22, which are each designed as circular end disks, which corresponds to approximately 30% of the length of the first filter element 12, whereby a chamber region is formed between the end disks, which has a volume share of the first inner chamber 28 of approximately 30%.

In addition, the selected design of the filter elements causes a volume difference between the first inner chamber 28 and the second inner chamber 30, wherein the proportion of the second inner chamber 30 to the first inner chamber 28 is approximately 8%. The flow area available for the fluid passage, i.e., the filter surface area available for a flow, is significantly larger for the first filter element 12 than for the second filter element 16 due to the different radii and the different lengths of the filter elements.

The first filter medium 14 and the second filter medium 18 are each circumferentially arranged fold packages made of a polyester-based filter material with a plurality of substantially uniform folds, which each extend in the axial direction A over the entire length and the entire circumference of the particular filter elements. In the preferred example shown, the first filter medium 14 has a bending strength of approximately 18.4 N*mm² and the second filter medium 18 has a bending strength of about 9.12 N*mm², wherein the bending strength is measured according to DIN 53864:1978-08 with a bending angle of 5° and is related to the effective bending strength of the entire filter medium.

The quotient of the filter reference rating of the first filter medium 14, namely 2.4 μm(c), divided by the filter reference rating of the second filter medium 18, namely 2.2 μm(c), is 1.09 in the example shown.

The cover element 24, which is also designed as a circular end disk, has a central fluid outlet 26 for discharging a fluid introduced into the filter insert 10. The first base element 20 has an optional water outlet opening 36 in the example shown in order to enable the removal of separated water for a two-stage water separation integrated in the filter insert 10.

When used in a fluid filter device, for example a fuel filter in a truck, the filter insert 10 shown in FIG. 2 is arranged in a filter housing of the fluid filter device, in particular as a main filter or high-efficiency filter. A fluid to be filtered, for example a fuel such as diesel, can flow according to a flow direction shown in FIG. 2 as direction arrows against the radial direction R from the outside through the first filter element 12 into the first inner chamber 28, from the first inner chamber 28 through the second filter element 16 into the second inner chamber 30 and from the second inner chamber 30 through the fluid outlet 26. Because the filter stages, represented by the first filter element 12 and the second filter element 16, are arranged one behind the other, a two-stage filtering along the usual operating direction is made possible, wherein an improved damping resistance of the filter insert 10 is achieved, in the opinion of the inventors, not only by the inventive choice of the bending strengths and filter ratings of the filter media, but in the preferred embodiment shown in particular also by the fluid flow which is at least partially deflected in the first inner chamber 28 and which results from the shortened second filter stage.

In vibration-free operation, the filter insert 10 shown can, for example, achieve an overall separation efficiency of 99.7% for particles with an average diameter of 4 μm with a continuous fluid flow. This filter performance is also advantageously achieved when filtering under mechanical stress, such as occurs in typical vehicle operation, in particular under vibrations and fluctuating fluid flows. The filter performance under the influence of vibrations and dynamically fluctuating volume flows of the fluid can be kept high in an advantageous manner with the filter insert 10 shown.

FIG. 3 shows a schematic cross-sectional representation in the plane orthogonal to the axial direction A through a filter insert 10 according to the invention in an alternative preferred embodiment. In this embodiment, the first filter element 12 is formed by the first filter medium 14 and by a fluid-permeable circumferential coalescer layer 32. In the example shown, the coalescer layer 32 is folded complementarily to the first filter medium 14 and is arranged in the radial direction R inside the first filter element 12. It extends in the axial direction A over the entire length of the first filter element 12. The coalescer layer 32 consists of open-pored nonwoven materials in order to coagulate liquid contaminants, in particular water, dispersed in the fluid.

In the example shown, the second filter element 16 is formed by the second filter medium 18 and by a fluid-permeable circumferential separation layer 34 for separating liquid contaminants present in the fluid. The separation layer 34 is folded complementarily to the second filter medium 18 and is arranged on the outside in the radial direction R in the second filter element 16. It extends in axial direction A over the entire length of the second filter element 16. The separation layer 34 is designed as a sieve-like layer and consists of a hydrophobically treated polyester.

In the embodiment shown in FIG. 3, the first base element 20 in any case comprises the central water outlet opening 36, which is designated as optional in FIG. 2, in order to drain the liquid contaminants separated on the coalescer layer 32 and the separation layer 34, in most practical cases in particular water, from the filter insert 10.

In the following, the invention and preferred embodiments of the invention are further explained and described with reference to an experiment and the results shown in FIG. 4 to 6.

### Experiment

The inventors investigated the overall removal efficiency of three selected filter cartridges, hereinafter referred to as A, B and C, under different loading conditions in order to evaluate the performance of the filter cartridges for the removal of particles with an average diameter of 4 μm or more under operating conditions encountered in practice under service conditions.

### Filter Inserts Examined:

The filter inserts A and B represent two different commercially available filter inserts with a structure according to FIG. 1a), although different first filter media were used. The first filter medium of filter insert A has a filter reference rating of 4.3 μm(c) with a bending strength of 22.8 N*mm². The first filter medium of filter insert B, on the other hand, has a filter reference rating of 2.4 μm(c) with a bending strength of 18.4 N*mm².

The filter insert C is a filter insert according to the invention, which is designed according to FIG. 2. The bending strength of the first and second filter medium is 18.4 N*mm² or 18.4 N*mm². The quotient of the filter reference ratings of the filter media is 1. The length of the first filter element is approximately 1.4 times the length of the second filter element.

### Experimental Procedure:

The measurement of the overall separation efficiency was carried out in accordance with ISO 19438:2003-11 for particles with a particle size of ≥4 μm, but diesel was used as the test fluid and the load scenarios described below were applied. The filters examined were dusted in the usual way before use in the measuring procedure. For the measurements, filter inserts A, B and C were exposed to different loading conditions in an overall of seven phases for a defined test period. In a load scenario 1, the separation efficiencies of the filter inserts were measured in a vibration-free and fluctuation-free state, i.e., at a constant volume flow of a fluid flowing through the filter insert without mechanical vibrations, which is also referred to as “steady state.”

In a load scenario 2, the filter inserts were each loaded with a mechanical vibration frequency to simulate the vibrations occurring during vehicle use.

In a load scenario 3, the filter inserts were each loaded with a fluctuating flow of the fluid to be filtered, the flow rate of which was cyclically alternated between 100% and 25% of the nominal flow rate for one minute each.

In a load scenario 2&3, the load scenarios 2 and 3 described above were created simultaneously.

### Results:

The results of the measurements are represented graphically in FIG. 4, wherein the Y-axis represents the overall separation efficiency for particles with a particle size ≥4 μm in % and the X-axis represents the test time in seconds. Over the entire test period of 10,000 s, the filter inserts A, B and C were successively exposed to the load scenarios described above and also shown graphically, wherein the corresponding phases with mechanical stress were each separated by time intervals in the “steady state,” so that the measurement comprises an overall of 7 phases.

From FIG. 4, it is clearly visible that the filter insert A in load scenario 2 has an overall separation efficiency of less than 50% and thus experiences high losses in separation efficiency compared to the filter insert C according to the invention. In load scenario 3, a reduced separation efficiency of filter insert A is also evident, which would make it unusable for many applications. However, for a combination of the load scenarios in load scenario 2&3, the overall separation efficiency of filter insert A drops so much that in many cases it can no longer be meaningfully determined and is below 40% in all cases. The filter insert B still shows acceptable filter performance in the isolated load scenarios 2 and 3.

However, in the combined load scenario 2&3, a strong oscillation of the overall separation efficiency is observed, wherein the average overall separation efficiency is significantly below 90%.

To illustrate the significant improvement in the robustness of the filter insert C according to the invention compared to the filter inserts A and B, FIG. 5 shows a detail of FIG. 4, which shows the separation efficiency in the time interval of the load scenario 2&3 in an enlarged manner. It can be clearly seen that the filter insert C according to the invention has an excellent overall separation efficiency of over 99.7% at all times and only a relatively small scatter of the measured values can be observed.

Accordingly, the average overall separation efficiency resulting in load scenario 2&3 for the filter insert C according to the invention is 99.90%, while the filter insert B can only achieve an average of 82.95% and the filter insert A even less than 10%, as shown in FIG. 6. Accordingly, this experiment not only demonstrates the significant improvement in the consistency of the achievable filter performance with filter inserts C according to the invention under operating conditions on the vehicle, i.e., in particular under mechanical vibrations and dynamically fluctuating volume flows, but also documents the consistently high separation values that can be achieved with filter inserts according to the invention.

### LIST OF REFERENCE SIGNS

10 filter insert
12 first filter element
14 first filter medium
16 second filter element
18 second filter medium
20 first base element
22 second base element
24 cover element
26 fluid outlet
28 first inner chamber
30 second inner chamber
32 coalescer layer
34 separation layer
36 water outlet opening
A axial direction
R radial direction

1. A filter insert for a fluid filter device, comprising:
a) a circumferential first filter element comprising a folded first filter medium, b) a circumferential second filter element comprising a folded second filter medium, c) a first base element and a second base element, and d) a cover element with a fluid outlet,
wherein the first filter element, the first base element, and the cover element form a first inner chamber, said second filter element being arranged in the first inner chamber, and the second filter element, the second base element, and the cover element form a second inner chamber,
wherein the distance between the first base element and the second base element in the axial direction is in the range of 0.1*L₁ to 0.6*L₁, wherein L₁ is the length of the first filter element in the axial direction,
wherein the filter insert is designed so that a fluid to be filtered can flow from the outside through the first filter element into the first inner chamber, from the first inner chamber through the second filter element into the second inner chamber and out of the second inner chamber through the fluid outlet,
wherein the quotient of the accessible filter surface area of the first filter element divided by the accessible filter surface area of the second filter element is greater than one,
wherein the quotient of the filter rating of the first filter medium divided by the filter rating of the second filter medium equals one or more, wherein the filter rating is the filter rating determined according to ISO 19438:2003-11 for the overall separation efficiency, wherein the first filter medium has a bending strength according to DIN 53864:1978-08 of 10 N*mm² or more, wherein the bending strength is determined with a bending angle of 5°,
wherein the second filter medium has a bending strength of 2.5 N*mm² or more according to DIN 53864:1978-08, wherein the bending strength is determined with a bending angle of 5°, and
wherein the quotient of the bending strength of the first filter medium divided by the bending strength of the second filter medium equals one or more.

2. The filter insert according to claim 1, wherein the quotient of the filter rating of the first filter medium divided by the filter rating of the second filter medium is 1.01 or more.

3. The filter insert according to claim 1, wherein the distance between the first base element and the second base element in the axial direction is in the range of 0.2*L₁ to 0.5*L₁, wherein L₁ is the length of the first filter element in the axial direction.

4. The filter insert according to claim 3, wherein the quotient of the bending strength of the first filter medium divided by the bending strength of the second filter medium is 1.1 or more.

5. The filter insert according to claim 1 wherein the first filter element is 10% or more longer in the axial direction than the second filter element.

6. The filter insert according to claim 1, wherein the first filter element and the second filter element are spaced apart from one another in the radial direction, so that the first inner chamber comprises an intermediate region arranged between the first filter element and the second filter element, wherein the average distance is in the range of 3 to 20 mm.

7. The filter insert according to claim 1 wherein the volume of the second inner chamber is 0.6*V₁ or less, wherein Vi is the volume of the first inner chamber.

8. The filter insert according to claim 1, wherein the first filter element comprises a fluid-permeable circumferential coalescer layer for agglomerating liquid contaminants dispersed in the fluid, and wherein the first base element comprises a water outlet opening.

9. The filter insert according to claim 1, wherein the second filter element comprises a fluid-permeable circumferential separation layer for separating liquid contaminants present in the fluid.

10. A fluid filter device for filtering a fluid, comprising:
i) a filter housing, and
ii) a filter insert arranged in the filter housing according to claim 1.

11. The fluid filter device according to claim 10, wherein the quotient of the filter rating of the first filter medium divided by the filter rating of the second filter medium is 1.01 or more.

12. The fluid filter device according to claim 10, wherein the distance between the first base element and the second base element in the axial direction is in the range of 0.2*L₁ to 0.5*L₁, wherein L₁ is the length of the first filter element in the axial direction.

13. The fluid filter device according to claim 12, wherein the quotient of the bending strength of the first filter medium divided by the bending strength of the second filter medium is 1.1 or more.

14. The fluid filter device according to claim 10, wherein the first filter element is 10% or more longer in the axial direction than the second filter element.

15. The fluid filter device according to claim 10, wherein the first filter element and the second filter element are spaced apart from one another in the radial direction, so that the first inner chamber comprises an intermediate region arranged between the first filter element and the second filter element, wherein the average distance is in the range of 3 to 20 mm.

16. The fluid filter device according to claim 10, wherein the volume of the second inner chamber is 0.6*V₁ or less, wherein V₁ is the volume of the first inner chamber.

17. The fluid filter device according to claim 10, wherein the first filter element comprises a fluid-permeable circumferential coalescer layer for agglomerating liquid contaminants dispersed in the fluid, and wherein the first base element comprises a water outlet opening.

18. The fluid filter device according to claim 10, wherein the second filter element comprises a fluid-permeable circumferential separation layer for separating liquid contaminants present in the fluid.
